(19) United States
(12) Patent Application Publication
(10) Pub. No.: US 2022/0095639 A1
(43) Pub. Date: Mar. 31, 2022

(54) LIGHT AND CONVENIENT PNEUMATIC TEA BRICK PREPARING DEVICE

(71) Applicant: KAM FUNG MAK, Hong Kong (CN)

(72) Inventor: KAM FUNG MAK, Hong Kong (CN)

(21) Appl. No.: 17/037,790

(22) Filed: Sep. 30, 2020

(51) Int. Cl. A23F 3/06; B30B 1/38; B30B 9/28

(52) U.S. Cl. CPC A23F 3/06; A23V 2300/46; B30B 9/28; B30B 1/38

(57) ABSTRACT

The invention discloses a light and convenient pneumatic tea brick preparing device, including a work table, a supporting device provided at a bottom of the work table, a punching device provided at a top of the supporting device and a limiting device provided at a top of the work table. An upwardly open rectangular accommodating cavity is provided at the bottom of the work table. The supporting device includes a supporting component, the punching device includes a power component, a punching component and a waterproof component, and the punching component includes a punching block. In this device, a working bin for holding tea leaves is formed by the limiting block, the rectangular accommodating cavity and the punching block, and the tea leaves in the working bin are punched by the punching block to form a tea brick which can be ejected together with the limiting block.

### TECHNICAL FIELD

The invention relate to a field of a tea processing technology, in particular to a light and convenient pneumatic tea brick preparing device.

### BACKGROUND ART

A tea brick is made by pressing boiled tea leaves with a mold, which is very popular in some areas. However, in making the tea brick, the mold generally is defined with a closed accommodating cavity, and it is often difficult to take out the tea brick after it is pressed in the mold and dried, or the tea brick is loose after being taken out. Aiming at this phenomenon, a small-sized tea brick preparing device is designed, which facilitates a preparing and taking out of the tea brick.

### SUMMARY

Viewing shortcomings in the prior art, an object of the invention is to provide a light and convenient pneumatic tea brick preparing device.

To solve the above problems, the present invention provides the following technical scheme:

a light and convenient pneumatic tea brick preparing device, including a work table, a supporting device provided at a bottom of the work table, a punching device provided at a top of the supporting device and a limiting device provided at a top of the work table; an upwardly open rectangular accommodating cavity being provided at the bottom of the work table; the supporting device including a supporting component which is fixedly arranged at the bottom of the work table; the punching device including a power component, a punching component and a waterproof component, the power component being fixedly arranged on a top of the supporting component and the punching component being fixedly arranged on an output of the power component, the waterproof component being sleeved on the output of the power component, and the punching component including a punching block which is arranged inside the rectangular accommodating cavity, and a bulge for receiving the punching block being provided at a bottom of the rectangular accommodating cavity; and the limiting device including a limiting component which includes a limiting block arranged at a top of the rectangular accommodating cavity, and the punching block, the rectangular accommodating cavity and the limiting block forming a working bin for preparing a tea brick.

Further, the power component includes a first cylinder and a cylinder shaft arranged on a top of the first cylinder, the first cylinder is fixedly arranged on the top of the supporting component, the cylinder shaft is arranged on the top of the first cylinder, and the punching block is fixedly arranged on the top of the cylinder shaft.

Further, the waterproof component includes a water receiving pan sleeved on the cylinder shaft and positioned at a top of the first cylinder.

Further, the supporting component includes four supporting legs and a supporting plate for fixing the first cylinder, the four supporting legs are distributed at the bottom of the work table in a rectangular shape, and the supporting plate is horizontally and fixedly arranged on the four supporting legs.

Further, the limiting component further includes a limiting cover which is arranged at the top of the work table and an end of which is hinged with the work table, and a plurality of snaps are provided at an end of the limiting cover away from the hinging part, and a plurality of clamping blocks are provided on a side wall of the work table, and each snap is in clamping fit with each clamping block.

Further, the limiting block and the punching block are rectangular plate-shaped structures with a same size and are consistent with a cross-sectional size of the rectangular accommodating cavity.

Further, stripes for punching and forming are provided at a bottom of the limiting block, and stripes for punching and shaping are provided at a top of the punching block.

The light and convenient pneumatic tea brick preparing device has the advantages that a working bin for holding tea leaves is formed by the limiting block, the rectangular accommodating cavity and the punching block, and the tea leaves in the working bin are punched by the punching block to form a tea brick, and the punched tea brick can be ejected together with the limiting block, which facilitates its taking out, and the water receiving pan is provided at the bottom of the work table for receiving water generated in an extrusion process, in which the machine is small and convenient, and is convenient for a small-scale processing, manufacturing and use.

### BRIEF DESCRIPTION OF DRAWINGS

FIG. 1 is a stereoscopic view of a structure of a light and convenient pneumatic tea brick preparing device according to the present invention;

FIG. 2 is a front view of a light and convenient pneumatic tea brick preparing device according to the present invention;

FIG. 3 is a sectional view taken along line A-A in FIG. 2;

FIG. 4 is a stereoscopic view of a separate structure of a light and convenient pneumatic tea brick preparing device according to the present invention.

Reference numbers in the figures are as follows: Work Table 1, Rectangular Accommodating Cavity 1a, Bulge 1b, Supporting Device 2, Supporting Component 2a, Supporting Leg 2b, Supporting Plate 2c, Punching Device 3, Power Component 3a, Punching Component 3b, Waterproof Component 3c, Punching Block 3d, First Cylinder 3e, Cylinder Shaft 3f, Water Receiving Pan 3g, Limiting Device 4, Limiting Component 4a, Limiting Block 4b, Limiting Cover 4c, Snap 4d and Clamping Block 4e.

### DETAILED DESCRIPTION OF PREFERRED EMBODIMENTS

Specific embodiments of the present invention will be described in further detail below with reference to the drawings and embodiments of the specification.

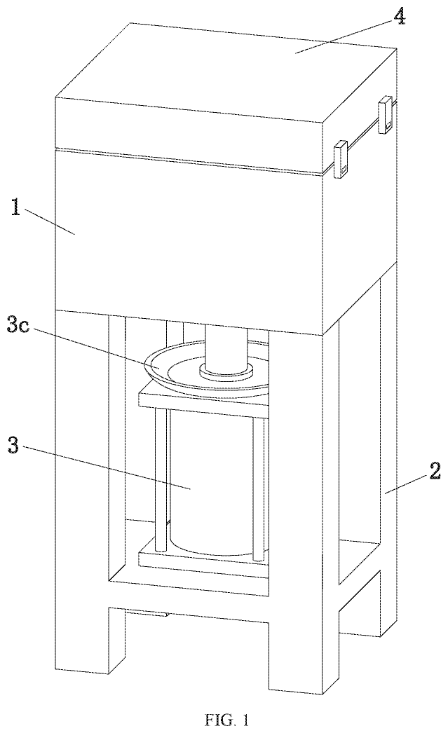

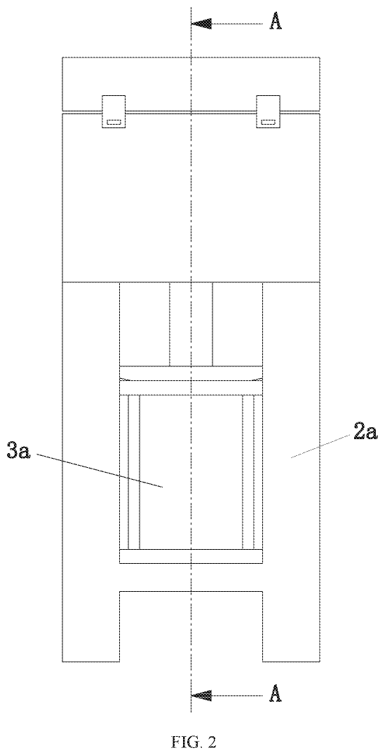

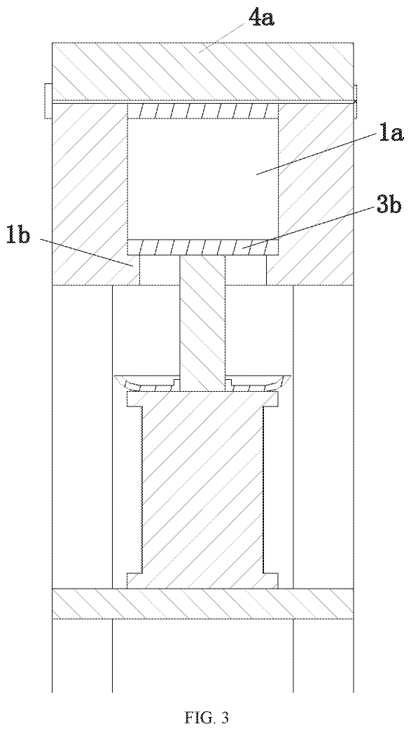

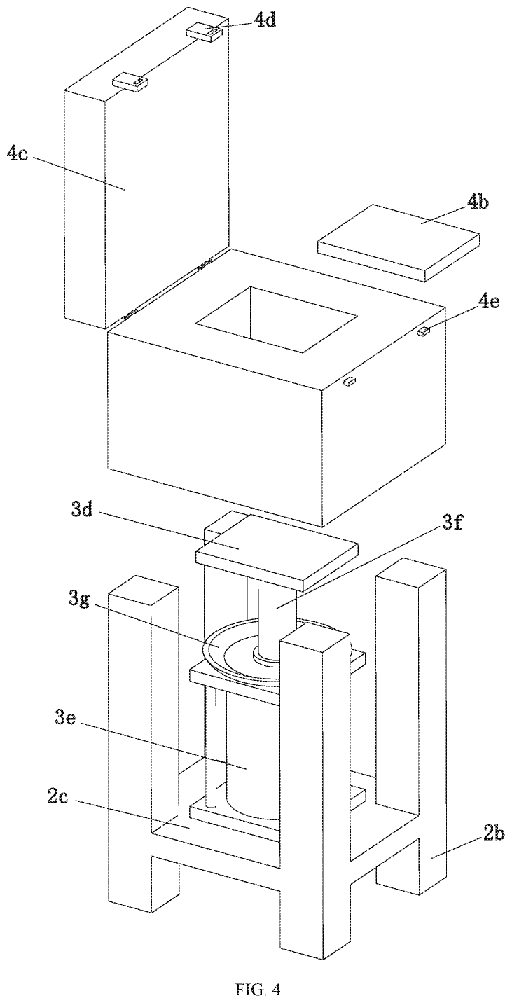

With reference to FIGS. 1 to 4, a light and convenient pneumatic tea brick preparing device includes a work table 1, a supporting device 2 provided at a bottom of the work table 1, a punching device 3 provided at a top of the supporting device 2 and a limiting device 4 provided at a top of the work table 1. An upwardly open rectangular accommodating cavity 1a is provided at the bottom of the work table 1. The supporting device 2 includes a supporting component 2a which is fixedly arranged at the bottom of the work table 1. The punching device 3 includes a power component 3a, a punching component 3b and a waterproof component 3c, the power component 3a is fixedly arranged on a top of the supporting component 2a and the punching component 3b is fixedly arranged on an output of the power component 3a, the waterproof component 3c is sleeved on the output of the power component 3a, and the punching component 3b includes a punching block 3d which is arranged inside the rectangular accommodating cavity 1a, and a bulge 1b for receiving the punching block 3d is provided at a bottom of the rectangular accommodating cavity 1a. The limiting device 4 includes a limiting component 4a which includes a limiting block 4b arranged at a top of the rectangular accommodating cavity 1a, and the punching block 3d, the rectangular accommodating cavity 1a and the limiting block 4b form a working bin for preparing a tea brick. The rectangular accommodating cavity 1a in the work table 1 is a place where a tea brick are formed. The supporting component 2a, on one hand, supports the work table 1, and on the other hand is used to support the power component 3a, and the power component 3a provides a power in a vertical direction so that the punching block 3d can move up and down in the rectangular accommodating cavity 1a. The limiting block 4b is used to limit an upward movement of the punching block 3d, which will extrude the steamed tea leaves in an upward punching process of the punching block 3d, and the waterproof component 3c is used to receive the water generated in the punching.

The power component 3a includes a first cylinder 3e and a cylinder shaft 3f arranged on a top of the first cylinder 3e, the first cylinder 3e is fixedly arranged on the top of the supporting component 2a, the cylinder shaft 3f is arranged on the top of the first cylinder 3e, and the punching block 3d is fixedly arranged on the top of the cylinder shaft 3f. When the first cylinder 3e is activated, the first cylinder 3e drives the cylinder shaft 3f to move upwards and simultaneously drives the punching block 3d to move upwards.

The waterproof component 3c includes a water receiving pan 3g sleeved on the cylinder shaft 3f and positioned at a top of the first cylinder 3e. In an upward moving and extruding of the punching block 3d, water in the boiled tea leaves is extruded, and the water receiving pan 3g is used for receiving the water.

The supporting component 2a includes four supporting legs 2b and a supporting plate 2c for fixing the first cylinder 3e, the four supporting legs 2b are distributed at the bottom of the work table 1 in a rectangular shape, and the supporting plate 2c is horizontally and fixedly arranged on the four supporting legs 2b. The four supporting legs 2b are mainly used to support the work table 1, and the supporting plate 2c is mainly used to support and fix the first cylinder 3e.

The limiting component 4a also includes a limiting cover 4c which is arranged at the top of the work table 1 and an end of which is hinged with the work table 1, and a plurality of snaps 4d are provided at an end of the limiting cover 4c away from the hinging part, and a plurality of clamping blocks 4e are provided on a side wall of the work table 1, and each snap 4d is in clamping fit with each clamping block 4e. A proper amount of boiled tea leaves are placed in the rectangular accommodating cavity 1a, and then a limiting block 4b is covered, the limit cover 4c is rotated to cover and the snaps 4d are snapped on.

The limiting block 4b and the punching block 3d are rectangular plate-shaped structures with a same size and are consistent with a cross-sectional size of the rectangular accommodating cavity 1a. The punching block 3d, the limiting block 4b and the rectangular accommodating cavity 1a have a same cross-sectional size, so that a cuboid tea brick can be extruded through the extrusion process.

Stripes for punching and forming are provided at a bottom of the limiting block 4b, and stripes for punching and shaping are provided at a top of the punching block 3d. When a surface of the tea brick needs to be shaped with increased stripes, it can be done through changing the stripes on the surfaces of the limiting block 4b and the punching block 3d.

A working principle is as follows: firstly, the limit cover 4c is opened, the limit block 4b is taken out, and a proper amount of boiled tea can be placed into the rectangular accommodating cavity 1a followed by covering with the limit block 4b; then the limit cover 4c is rotated to cover the rectangular accommodating cavity followed by snapping on the snaps 4d; after this, the first cylinder 3e will be activated to drive the cylinder shaft 3f to move upwards and drive the punch block 3d to move upwards at the same time; and since the limit block 4b is in a stationary state, the punch block 3d moves upwards and extrude, which extrudes out the water in the tea leaves, and the water receiving pan 3g is used to receive the water to avoid a pollution. After the extruding and forming is finished, the first cylinder 3e is deactivated and the limit cover 4c is opened, and at this time, the tea brick is formed but is not easy to take out; following this, the first cylinder 3e can be activated again to eject the limit block 4b along with the tea brick. At this time, the formed tea brick can be taken out.

The above is only preferred embodiments of the present invention, and does not limit the technical scope of the present invention. Therefore, any slight modifications, equivalent changes and modifications made to the above embodiments according to the technical essence of the present invention still fall within the scope of the technical scheme of the present invention.

1. A light and convenient pneumatic tea brick preparing device, wherein it comprises a work table (1), a supporting device (2) provided at a bottom of the work table (1), a punching device (3) provided at a top of the supporting device (1) and a limiting device (4) provided at a top of the work table (1); an upwardly open rectangular accommodating cavity (1a) being provided at the bottom of the work table (1); the supporting device (2) including a supporting component (2a) which is fixedly arranged at the bottom of the work table (1); the punching device (3) comprising a power component (3a), a punching component (3b) and a waterproof component (3c), the power component (3a) being fixedly arranged on a top of the supporting component (2a) and the punching component (3b) being fixedly arranged on an output of the power component (3a), the waterproof component (3c) being sleeved on the output of the power component (3a), and the punching component (3b) comprising a punching block (3d) which is arranged inside the rectangular accommodating cavity (1a), and a bulge (1b) for receiving the punching block (3d) being provided at a bottom of the rectangular accommodating cavity (1a); and the limiting device (4) including a limiting component (4a) which includes a limiting block (4b) arranged at a top of the rectangular accommodating cavity (1a), and the punching block (3d), the rectangular accommodating cavity (1a) and the limiting block (4b) forming a working bin for preparing a tea brick;
the power component (3a) comprising a first cylinder (3e) and a cylinder shaft (3f) arranged on a top of the first cylinder (3e), the first cylinder (3e) being fixedly arranged on the top of the supporting component (2a), the cylinder shaft (3f) being arranged on the top of the first cylinder (3e), and the punching block (3d) being fixedly arranged on the top of the cylinder shaft (3f); and the limiting component (4a) further comprising a limiting cover (4c) which is arranged at the top of the work table (1) and an end of which is hinged with the work table (1), and a plurality of snaps (4d) being provided at an end of the limiting cover (4c) away from a hinging part, and a plurality of clamping blocks (4e) being provided on a side wall of the work table (1), and each snap (4d) is in clamping fit with each clamping block (4e).

2. The light and convenient pneumatic tea brick preparing device according to claim 1, wherein the waterproof component (3c) comprises a water receiving pan (3g) sleeved on the cylinder shaft (3f) and positioned at a top of the first cylinder (3e).

3. The light and convenient pneumatic tea brick preparing device according to claim 1, wherein the supporting component (2a) comprises four supporting legs (2b) and a supporting plate (2c) for fixing the first cylinder (3e), the four supporting legs (2b) being distributed at the bottom of the work table (1) in a rectangular shape, and the supporting plate (2c) is horizontally and fixedly arranged on the four supporting legs (2b).

4. The light and convenient pneumatic tea brick preparing device according to claim 1, wherein the limiting block (4b) and the punching block (3d) are rectangular plate-shaped structures with a same size and are consistent with a cross-sectional size of the rectangular accommodating cavity (1a).

5. The light and convenient pneumatic tea brick preparing device according to claim 4, wherein a stripe for punching and shaping is provided at a bottom of the limiting block (4b), and a stripe for punching and shaping is provided at a top of the punching block (3d).
